(19) United States
(12) Patent Application Publication
(10) Pub. No.: US 2023/0419929 A1
(43) Pub. Date: Dec. 28, 2023

(54) SIGNAL PROCESSING SYSTEM, SIGNAL PROCESSING METHOD, AND PROGRAM

(71) Applicant: Yamaha Corporation, Hamamatsu (JP)

(72) Inventor: Akira MAEZAWA, Hamamatsu (JP)

(21) Appl. No.: 18/463,059

(22) Filed: Sep. 7, 2023

Related U.S. Application Data
(63) Continuation of application No. PCT/JP21/23831, filed on Jun. 23, 2021.
(60) Provisional application No. 63/158,368, filed on Mar. 9, 2021.

(51) Int. Cl. G10H 1/00

(52) U.S. Cl. CPC G10H 1/0008; G10H 1/0041

(57) ABSTRACT

A signal processing system causes a reproduction device to reproduce a time series signal that follows reproduction of a musical piece. The signal processing system includes an electronic controller including at least one processor. The electronic controller is configured to execute a plurality of units including an acquisition unit configured to acquire an indicated position indicated by a user in the reproduction of the musical piece, and a control unit configured to execute time stretching of the time series signal in accordance with the indicated position.

### CROSS-REFERENCE TO RELATED APPLICATIONS

This application is a continuation application of International Application No. PCT/JP2021/023831, filed on Jun. 23, 2021, which claims priority to U.S. Provisional Patent Application No. 63/158,368, filed on Mar. 9, 2021. The entire disclosures of International Application No. PCT/JP2021/023831 and U.S. Provisional Patent Application No. 63/158,368 are hereby incorporated herein by reference.

### BACKGROUND

### Technological Field

The present disclosure relates to technology for processing time domain signals (hereinafter referred to as “time series signals”) such as audio or video signals.

### Background Information

Various techniques for estimating the position (hereinafter referred to as the “performance position”) on the time axis of a musical piece that is being played by a performer have been proposed in the prior art. For example, Japanese Laid-Open Patent Application No. 2015-79183 discloses a technology for analyzing an audio signal representing the performance sound of a musical piece to estimate the performance position.

### SUMMARY

For example, there is a demand to make the reproduction of sound as it is represented by audio signals, or of video as it is represented by video signals, follow (synchronize to) the performance of a user. In this regard, the object of one aspect of the present disclosure is to make a time series signal, such as an audio signal or a video signal, follow the actions of a user.

In order to solve this problem, a signal processing system according to one aspect of this disclosure is a signal processing system for causing a reproduction device to reproduce a time series signal that follows reproduction of a musical piece. The signal processing system includes an electronic controller including at least one processor. The electronic controller is configured to execute a plurality of units including an acquisition unit configured to acquire an indicated position indicated by a user in the reproduction of the musical piece, and a control unit configured to execute time stretching of the time series signal in accordance with the indicated position.

A signal processing method according to one aspect of this disclosure is a method for causing a reproduction device to reproduce a time series signal following reproduction of a musical piece, comprising acquiring an indicated position indicated by a user in the reproduction of the musical piece, and executing time stretching of the time series signal in accordance with the indicated position.

A non-transitory computer-readable medium storing a program according to one aspect of this disclosure causes a reproduction device to reproduce a time series signal following reproduction of a musical piece, and that causes a computer to execute a process including acquiring an indicated position indicated by a user in the reproduction of the musical piece, and executing time stretching of the time series signal in accordance with the indicated position.

### BRIEF DESCRIPTION OF THE DRAWINGS

FIG. 1 is a block diagram showing the configuration of a performance system according to a first embodiment.

FIG. 2 is a block diagram showing the functional configuration of a signal processing system.

FIG. 3 is an explanatory diagram of the process executed by an acquisition unit and an identification unit.

FIG. 4 is a flowchart showing the specific procedure of a control process.

FIG. 5 is an explanatory diagram of an identification process for identifying a performance position.

FIG. 6 is a flowchart showing the specific procedure of an identification process.

FIG. 7 is a flowchart showing the specific procedure of a part of a probability setting process.

FIG. 8 is a flowchart showing the specific procedure of another part of a probability setting process.

FIG. 9 is an explanatory diagram of an inter-sounding time interval.

FIG. 10 is a flowchart showing the specific procedure of a reproduction process.

FIG. 11 is an explanatory diagram of operating intensity.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

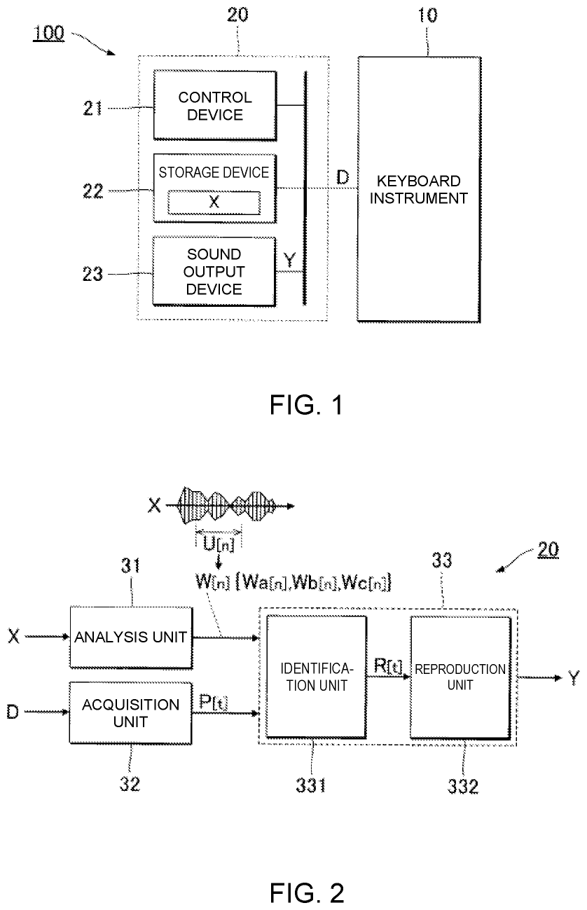

FIG. 1 is a block diagram showing the configuration of a performance system 100 according to a first embodiment. A performance system 100 is a computer system with which a user plays a musical piece (hereinafter referred to as “target musical piece”) and which is equipped with a keyboard instrument 10 and a signal processing system 20. The keyboard instrument 10 and the signal processing system 20 are interconnected by wire or wirelessly.

The keyboard instrument 10 is an electronic instrument provided with a plurality of keys corresponding to different pitches. A user sequentially operates the keys of the keyboard instrument 10 to perform a target musical piece. Specifically, by the keyboard instrument 10, the user plays one or more performance parts from among a plurality of performance parts constituting the target musical piece. The keyboard instrument 10 emits sound (for example, the sounds of an instrument) of the pitch played by the user. In addition, the keyboard instrument 10 supplies, to the signal processing system 20, performance data D representing said performance, in parallel with the emission of sound corresponding to the user's performance. The performance data D are instruction data specifying the pitch corresponding to the key played by the user and the intensity of the key depression, and are generated for each operation of the keyboard instrument 10 by the user. That is, the time-series performance data D is supplied from the keyboard instrument 10 to the signal processing system 20. The performance data D are event data conforming to the MIDI (Musical Instrument Digital Interface) standard.

The signal processing system 20 includes a control device 21, a storage device 22, and a sound output device 23. The signal processing system 20 is realized by a portable information device such as a smartphone or a tablet terminal, or a portable or stationary information device such as a personal computer. The signal processing system 20 can be realized as a single device, or as a plurality of devices which are separately configured. In addition, the signal processing system 20 can be installed in the keyboard instrument 10.

The control device 21 is an electronic controller that includes one or a plurality of processors that control each element of the signal processing system 20. For example, the control device 21 is configured to comprise one or more types of processors, such as a CPU (Central Processing Unit), an SPU (Sound Processing Unit), a DSP (Digital Signal Processor), an FPGA (Field Programmable Gate Array), an ASIC (Application Specific Integrated Circuit), or the like. Here, the term “electronic controller” as used herein refers to hardware, and does not include a human. As discussed below, the control device 21 is configured to execute a plurality of units including an analysis unit 31, an acquisition unit 32, and a control unit 33.

The storage device 22 includes one or more computer memories or memory units for storing a program that is executed by the control device 21 and various data that are used by the control device 21. A known storage medium, such as a magnetic storage medium or a semiconductor storage medium, or a combination of a plurality of various types of storage media, constitute the storage device 22. A portable storage medium that can be attached to or detached from the signal processing system 20 or a storage medium (for example, cloud storage) that the control device 21 can read from or write to via a communication network, such as the Internet can, also be used as the storage device 22. The storage device 22 is one example of a non-transitory storage medium.

The storage device 22 stores an audio signal X representing the performance sound of the target musical piece. The audio signal X is a time series signal (i.e., a sample sequence) representing a waveform of the performance sound of the target musical piece. Specifically, the audio signal X represents the musical sound produced by various musical instruments when the target musical piece is performed, or the sound of the voice produced by a singer when the target musical piece is sung. For example, the audio signal X represents the performance sound of one or more performance parts other than the performance part played by the user with the keyboard instrument 10, from among the plurality of performance parts constituting the target musical piece.

The sound output device 23 reproduces the sound indicated by the control device 21. The sound output device 23 is a loudspeaker or headphones, for example. The sound output device 23 that is separate from the signal processing system 20 can be connected to the signal processing system 20 wirelessly or by wire.

The control device 21 according to the first embodiment causes the sound output device 23 to reproduce the audio signal X, following the user's performance of the target musical piece. Specifically, the control device 21 estimates a position (performance position P[t]) of the target musical piece corresponding to the user's performance, and causes the sound output device 23 to reproduce a portion Y of the audio signal X corresponding to the position (reproduction position R[t]) on the time axis corresponding to said position. That is, the audio signal X is stretched or shrunk (time stretching) on the time axis, in accordance with the user's performance of the target musical piece. For example, when the speed of the user's performance is below a prescribed standard speed (hereinafter referred to as “standard speed”) Pθ, the audio signal X is stretched on the time axis. That is, the lower the movement speed of the performance position P[t], the more slowly the reproduction position R[t] moves on the time axis, and hence, the more that the audio signal X is stretched on the time axis. On the other hand, if the speed of the user's performance exceeds the standard speed Pθ, the audio signal X is shortened on the time axis. That is, the higher the movement speed of the performance position P[t], the faster the reproduction position R[t] moves on the time axis, and hence, the more the audio signal X is shortened on the time axis. As described above, since the reproduction of the audio signal X by the sound output device 23 follows the user's performance, an atmosphere is created as if the signal processing system 20 and the user are harmoniously playing together.

FIG. 2 is a block diagram showing the functional configuration of the signal processing system 20. The control device 21 executes a program that is stored in the storage device 22 to realize a plurality of functions (the analysis unit 31, the acquisition unit 32, and the control unit 33) for reproducing the audio signal X that follows the user's playing of the keyboard instrument 10.

The analysis unit 31 generates an index W[n] (Wa[n], Wb[n], Wc[n]) by analyzing audio signal X. The index W[n] (n=1−N) is generated for each of N time intervals (hereinafter referred to as “unit time interval”) U[1]-U[N] obtained by dividing the audio signal X on the time axis. Each unit time interval U[n] is a time interval of prescribed length. The symbol n indicates the number (frame number) of the unit time interval U[n]. A unit time interval U[n−1] and a unit time interval U[n] that are consecutive on the time axis partially overlap. However, the unit time interval U[n−1] and the unit time interval U[n] can be consecutive without overlapping.

Each index W[n] is a variable (feature amount) related to the acoustic characteristics of the audio signal X within the unit time interval U[n]. The analysis unit 31 generates an index W[n] (W[1]-W[N]) for each unit time interval U[n] before reproduction of the audio signal X and stores each index W[n] in the storage device 22. Specifically, the analysis unit 31 calculates a sound occurrence index Wa[n], a variation index Wb[n], and a sound generation point index Wc[n] as the index W[n] for each unit time interval U[n].

The sound occurrence index Wa[n] is a variable that indicates in binary form whether audio signal X during unit time interval U[n] represents sound or silence. That is, the sound occurrence index Wa[n] is set to the numerical value “1” when the unit time interval U[n] contains sound and is set to “0” when it is silent. A known voice activity detection (VAD) is used for the calculation of the sound occurrence index Wa[n]. The probability (for example, a numerical value between 0 and 1) that audio signal X contains sound during unit time interval U[n] can be used as the sound occurrence index Wa[n].

The variation index Wb[n] is a variable representing the degree of variation of the acoustic characteristics of audio signal X. For example, the amount of variation of the acoustic characteristics between consecutive unit time intervals U[n−1] and U[n] is calculated as the variation index Wb[n] of the unit time interval U[n]. Therefore, the more easily the acoustic characteristics of audio signal X fluctuate, the greater the numerical value to which the variation index Wb[n] is set. The acoustic characteristics are, for example, the intensity spectrum of the audio signal X or the frequency characteristics such as MFCC (Mel-Frequency Cepstrum Coefficient). The amount of variation of the acoustic characteristics, such as the fundamental frequency of audio signal X, etc., can be used as the variation index Wb[n]. A known analytical technique, such as the Discrete Fourier Transform, is used to calculate the variation index Wb[n]. That the acoustic characteristics fluctuate easily means that the acoustic characteristics of the audio signal X can easily fluctuate unstably. Therefore, the variation index Wb[n] is, in other words, an index of the stability or instability of the acoustic characteristics of audio signal X.

The sound generation point index Wc[n] is a variable that indicates in binary form whether the unit time interval U[n] of the audio signal X represents a sound generation point. The sound generation point is the point in time (onset) at which the generation of the acoustic component included in the audio signal X has started, i.e., the temporal rising point (attack) of the acoustic component. Any known analytical technique can be used to calculate the sound generation point index Wc[n]. For example, the point in time at which the volume of the audio signal X increases sharply is detected as the sound generation point. The probability (for example, a numerical value between 0 and 1) that the unit time interval U[n] of audio signal X is a sound generation point can be used as the sound generation point index Wc[n].

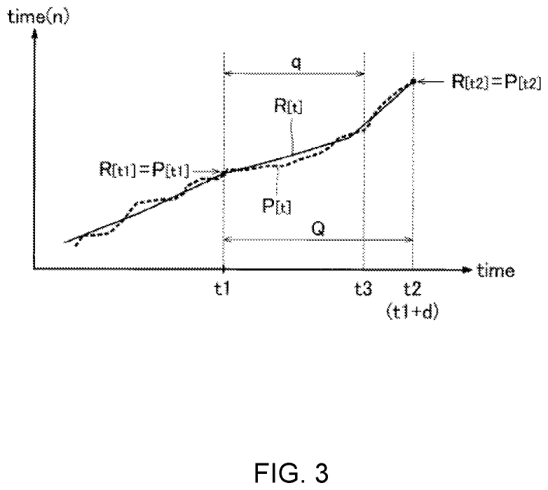

FIG. 3 shows an explanatory diagram of an overview of the processes of the control unit 33 and the acquisition unit 32 of FIG. 2. The acquisition unit 32 acquires the performance position P[t] over time. Specifically, the acquisition unit 32 analyzes the time series of the performance data D supplied sequentially from the keyboard instrument 10 to identify the performance position P[t] in the target musical piece. The symbol t indicates one of a plurality of time points set at equal intervals on the time axis. That is, the acquisition unit 32 identifies the performance position P[t] for each of a plurality of time points t on the time axis. A time point t is represented by a number for each time point set on the time axis. The performance position P[t] indicates the elapsed time (for example, seconds) from the starting point of audio signal X. The identification of the performance position P[t] by the acquisition unit 32 is repeated in parallel with the user's performance of the target musical piece and the reproduction of audio signal X. The speed with which the performance position P[t] moves on the time axis is a variable value that depends on the user's performance.

The acquisition unit 32 of the first embodiment estimates (i.e., predicts), for each time point t on the time axis, a performance position P[t+d] at a time point (t+d) that is after (forward of) said time point t by a prescribed length d. The prescribed length d is a prescribed positive number corresponding to an integer number of time points t. Any known analytical technique (score alignment technique) can be used by the acquisition unit 32 to estimate the performance position P[t]. For example, the analytical technique disclosed in Japanese Laid-Open Patent Application No. 2016-099512 can be used for the estimation of the performance position P[t]. In addition, the acquisition unit 32 can use a statistical estimation model, such as deep neural network (DNN) or a hidden Markov model (I-IMM) to estimate the performance position P[t].

The control unit 33 of FIG. 2 executes the time stretching of the audio signal X in accordance with the performance position P[t]. The control unit 33 of the first embodiment includes an identification unit 331 and a reproduction unit 332.

The identification unit 331 of FIG. 2 identifies the reproduction position R[t] corresponding to the performance position P[t]. The identification unit 331 identifies the reproduction position R[t] for each of multiple time points t on the time axis. The reproduction position R[t] is the elapsed time (for example, seconds) from the starting point of the audio signal X. That is, the reproduction position R[t] indicates that at a time point t on the time axis, the time point of audio signal X at which time R[t] has elapsed from the starting point will be reproduced. The identification unit 331 identifies the reproduction position R[t] from the performance position P[t], so that the reproduction position R[t] approximates the performance position P[t] and the audible naturalness of the reproduction sound of audio signal X is maintained.

FIG. 3 shows a processing time interval Q and an analysis time interval q. The processing time interval Q is the time interval between time point t1 and time point t2 on the time axis. Time point t1 corresponds to the current time point during reproduction of the audio signal X. Time point t2 is located after time point t1. Specifically, time point t2 is a time point t that follows time point t1 by a prescribed length d. That is, the processing time interval Q is a time interval of prescribed length d. As described above, at time point t1, the performance position P[t] up to time point (t1+d) has been estimated by the acquisition unit 32. That is, at time point t1, the performance position P[t] has been estimated for each time point t during processing time interval Q starting at said time point t1. On the other hand, at the arrival of time point t1, the reproduction position R[t] has not been specified for each time point t within processing time interval Q. Time point t1 is one example of a “first time point,” and time point t2 is one example of a “second time point.”

The analysis time interval q is a time interval from time point t1 to time point t3. Time point t3 is located between time point t1 and time point t2. Specifically, time point t3 is after time point t1, by a number of time points t below the prescribed length d. In other words, the analysis time interval q is part of the processing time interval Q on the starting point (t1) side. In FIG. 3, an example is shown in which time point t3 is closer to time point t2 than time point t1, but the position of time point t3 within processing time interval Q is arbitrary. For example, a time point t immediately following time point t1 can be the time point t3. Time point t3 is one example of a “third time point.”

The identification unit 331 estimates the time series of the reproduction position R[t] of each time point t within the analysis time interval q, of the processing time interval Q in which the performance position P[t] has been estimated, in accordance with the time series of the performance position P[t] within said processing time interval Q. That is, for each analysis time interval q on the time axis, the time series of the reproduction position R[t] corresponding to each time point t within said analysis time interval q is identified. In a configuration in which time point t3 is a time point t that immediately follows time point t1, the reproduction position R[t] is identified for each time point t on the time axis.

The accuracy with which the acquisition unit 32 estimates the performance position P[t] decreases with increasing distance of time t from the current time t1 on the time axis. In this regard, in the first embodiment, the time series of the reproduction position R[t] within the analysis time interval q from time point t1 to time point t3 is estimated in accordance with the time series of the performance position P[t] within the processing time interval Q from time point t1 to time point t2. Therefore, it reduces the influence of estimation error (noise) on the performance position P[t] during a time interval near the end of the processing time interval Q. That is, the reproduction position R[t] can be more appropriately identified compared to a configuration in which the time series of the performance position P[t] within the processing time interval Q is used to identify the time series of the reproduction positions R[t] over the entire processing time interval Q.

The reproduction unit 332 of FIG. 2 causes the sound output device 23 to reproduce the portion Y of the audio signal X corresponding to the reproduction position R[t]. Specifically, at each of a plurality of time points t on the time axis, the reproduction unit 332 causes the sound output device 23 to reproduce the portion Y of the audio signal X that includes the reproduction position R[t] of said time point t. The portion Y is composed of a time series of samples within a time interval corresponding to the reproduction position R[t] in audio signal X. The D/A converter that converts the portion Y of the audio signal X from digital to analog and the amplifier that amplifies the converted signal have been omitted from the figure for the sake of convenience. In the following description, it is assumed that audio signal X is reproduced in units of a prescribed time length (hop length) Ht.

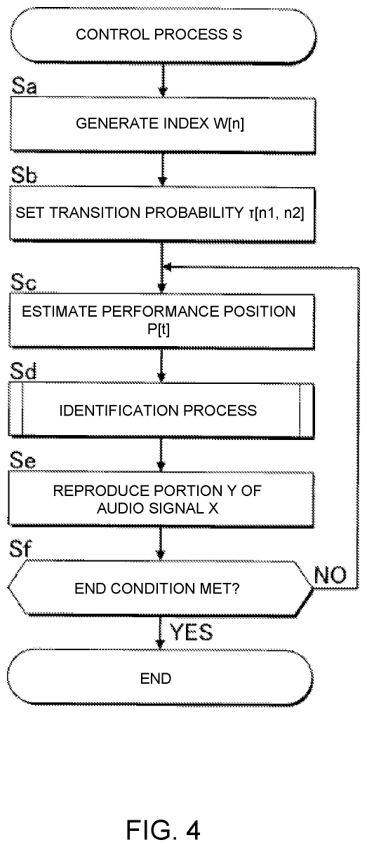

FIG. 4 is a flowchart showing the specific procedure of a process (hereinafter referred to as “control process”) S that is executed by the control device 21 to reproduce audio signal X. The control process S is initiated by, for example, an instruction from the user. When control process S is started, the analysis unit 31 analyzes audio signal X stored in the storage device 22 to generate an index W[n] (Wa[n], Wb[n], Wc[n]) for each of N unit time intervals U[1]-U[N] (Sa).

The identification unit 331 sets a transition probability τ[n1, n2] by analyzing audio signal X (Sb). Where a unit time interval U[n1] of audio signal X is reproduced at one time point (t−1) on the time axis, the transition probability τ[n1, n2] is the probability (n1, n2=1−N) that a unit time interval U[n2] of the audio signal X is reproduced at the immediately succeeding time point t. That is, the transition probability τ[n1, n2] means the probability that the reproduction position R[t] transitions from unit time interval U[n1] to unit time interval U[n2] of the audio signal X. The identification unit 331 calculates the transition probability τ[n1, n2] for all of the possible combinations of selecting the two unit time intervals U[n](U[n1] and U[n2]) from the N unit time intervals U[1]-U[N] of the audio signal X. Unit time interval U[n2] is a unit time interval U[n] (n2>n1) that follows unit time interval U[n1], or a unit time interval U[n] (n2=n1) that matches unit time interval U[n1]. The closer unit time interval U[n1] and unit time interval U[n2] related to the transition probability τ[n1, n2] are on the time axis, the greater the degree of stretching of the audio signal X. In addition, a transition probability τ[n, n] (n1=n2) in which n1 and n2 are the same means the probability that the reproduction position R[t] stays in said unit time interval U[n]. As can be understood from the foregoing explanation, the reproduction position R[t] moves forward on the time axis. However, a movement of the reproduction position R[t] in the backward direction on the time axis (past) can be allowed.

The calculation (Sa) of index W[n] and setting (Sb) of the transition probability τ[n1, n2] can be executed before control process S is initiated. In addition, the order of the calculation (Sa) of index W[n] and setting (Sb) of the transition probability τ[n1, n2] can be reversed. Index W[n] and transition probability τ[n1, n2] are stored in the storage device 22. When the preparatory processes (Sa, Sb) described above are executed, the acquisition unit 32 estimates the performance position P[t+d] for each time point t on the time axis (Sc).

The identification unit 331 executes an identification process Sd. The identification process Sd identifies the time series of the reproduction positions R[t] within analysis time interval q in accordance with each index W[n] of the audio signal X and the time series of performance positions P[t] within processing time interval Q. The identification process Sd is executed for each analysis time interval q on the time axis. The reproduction unit 332 causes the sound output device 23 to reproduce the portion Y of audio signal X that corresponds to each reproduction position R[t] identified by the identification process Sd (Se).

The control device 21 determines whether a prescribed end condition has been met (Sf). The end condition is, for example, the acceptance of an end instruction from the user, or of an indication that the reproduction of all of audio signal X has been completed. If the end condition is not satisfied (Sf: NO), the control device 21 causes the process to proceed to Step SC. That is, the estimation (Sc) of the performance position P[t+d], the identification (Sd) of the reproduction position R[t] within the analysis time interval q and the reproduction (Se) of portion Y of audio signal X are repeated. On the other hand, if the end condition is satisfied (Sf: YES), the control device 21 ends the control process S.

Each time the process is caused to proceed to Step SC (Sf: NO), the control device 21 sets the immediately succeeding processing time interval Q using the end point of analysis time interval q at the current time point (i.e., the time interval for which the time series of the reproduction positions R[t] has been identified) as the starting point, and also sets analysis time interval q within said processing time interval Q. That is, for each of the plurality of processing time intervals Q on the time axis, the identification unit 331 identifies the time series of the reproduction positions R[t] within the analysis time interval q of said processing time interval Q.

As described above, in the first embodiment, the sound output device 23 reproduces the portion Y of audio signal X that corresponds to the reproduction position R[t] corresponding to the user's performance position P[t]. In other words, the audio signal X is time-stretched (stretched or shrunk) on the time axis in accordance with the user's performance of the target musical piece. Therefore, the reproduction of audio signal X by the sound output device 23 can be made to follow the user's performance of the target musical piece.

The identification of the reproduction position R[t] will be described in detail below. The function F(P[t]) and the function E(n) are used in the following explanation. The function F(P[t]) is a function for converting the performance position P[t] (in seconds) to a number n of the unit time interval U[n] in the audio signal X, expressed, for example, by the following Equation (1).

F(P[t])=round{P[t]·fs/Hₙ} (1)

The symbol round{ } in Equation (1) means rounded off. The symbol fs is the sampling frequency of audio signal X. In addition, the symbol Hn is the time length (hop length) to be used as the unit of analysis of audio signal X. The hop length Ht related to the reproduction of the audio signal X exceeds the hop length Hn related to the analysis of audio signal X (Ht>Hn).

On the other hand, the function E(n) is a function for converting the number n of the unit time interval U[n] into elapsed time (for example, seconds) from the starting point of the audio signal X, expressed, for example, by the following Equation (2).

E(n)=n·Hₙ/fs (2)

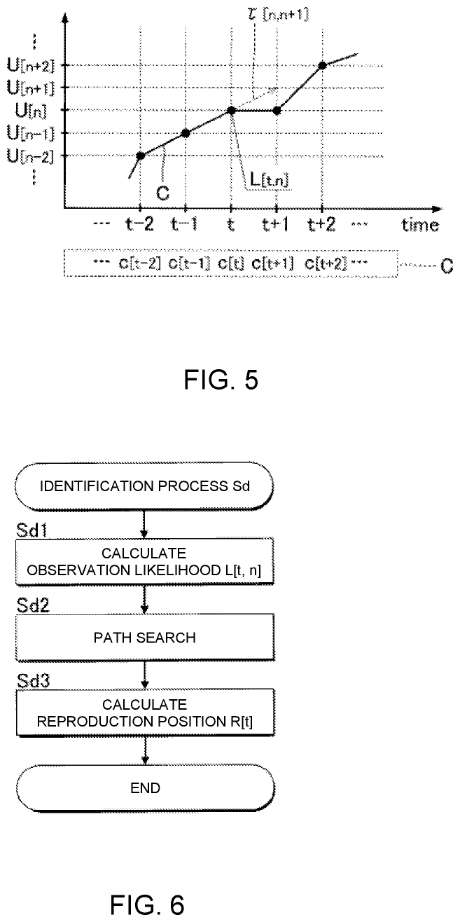

FIG. 5 shows an explanatory diagram of the aforementioned identification process Sd. FIG. 5 shows each time point t ( . . . , t−2, t−1, t, t+1, t+2, . . . ) on the time axis and each unit time interval U[n] ( . . . , U[n−2], U[n−1], U[n], U[n+1], U[n+2], . . . ) of audio signal X. The identification process Sd of the first embodiment includes a process (hereinafter referred to as “path search”) Sd2 for searching for a maximum likelihood path (hereinafter referred to as “maximum likelihood path”) C composed of different combinations of each unit time interval U[n] and each time point t. The maximum likelihood path C is represented by a time series of a plurality of position variables c[t] corresponding to different time points t on the time axis. Position variable c[t] designates any one of N unit time intervals U[1]-U[N] of the audio signal X (c[t]=1−N). Dynamic programming methods, such as the Viterbi algorithm or beam search, for example, are used for path search Sd2.

FIG. 6 is a flowchart showing a specific procedure of the identification process Sd. When the identification process Sd is started, the identification unit 331 calculates an observation likelihood L[t, n] for each time point t within the processing time interval Q (Sd1). The observation likelihood L[t, n] is the likelihood that the nth unit time interval U[n] of the N unit time intervals U[1]-U[N] of the audio signal X will be reproduced at time point t. That is, the observation likelihood L[t, n] indicates the probability that each unit time interval U[n] of audio signal X corresponds to the reproduction position R[t] at time point t.

The identification unit 331 estimates the maximum likelihood path C using the path search Sd2. The observation likelihood L[t, n] at each time point t within processing time interval Q and transition probability τ[n1, n2] of audio signal X are applied to path search Sd2. As described above, in the first embodiment, the time series of the reproduction positions R[t] can be appropriately identified by path search Sd2 to which is applied the transition probability τ[n1, n2] for each combination of two unit time intervals U[n] (U[n1], U[n2]) of audio signal X.

In path search Sd2, the identification unit 331 searches for maximum likelihood path C under a constraint condition in which position variable c[t1] at the beginning of the processing time interval Q (time point t1) and the position variable c[t2] at the end of the processing time interval Q (time point t2) are fixed. Specifically, position variable c[t1] at time point t1 is fixed to the numerical value F(P[t1]) obtained by converting by the function F(P[t]) of Equation (1) the performance position P[t1] estimated for said time point t1. The position variable c[t2] at time point t2 is fixed to the numerical value F(P[t2]) obtained by converting by the function F(P[t]) of Equation (1).the performance position P[t2] estimated for said time point t2

The maximum likelihood path C is represented by a time series of position variables c[t] corresponding to different time points t within the analysis time interval q, as described above. The identification unit 331 calculates the reproduction position R[t] for each time point t within the analysis time interval q by converting the number n of the unit time interval U[n] specified by each position variable c[t] by the function E(n), (Sd3). In other words, as shown in FIG. 3, the identification unit 331 of the first embodiment identifies the time series of the reproduction positions R[t] within the analysis time interval q under the constraint condition in which the reproduction position R[t1] at time point t1 of the analysis time interval q is fixed to the performance position P[t1] of the time point t1 and the reproduction position R[t2] at time point t2 of the analysis time interval q is fixed to the performance position P[t2] of the time point t2. By the configuration described above, the possibility of excessive deviation of the reproduction position R[t] from the performance position P[t] within the analysis time interval q is reduced.

As explained above, in the first embodiment, the path search Sd2 for identifying the time series of the reproduction positions R[t] is performed for each processing time interval Q on the time axis. Therefore, even if the speed of movement of the performance position P[t] fluctuates irregularly, it is possible to identify a reproduction position R[t] that accurately follows the user's performance.

The observation likelihood L[t, n] and transition probability τ[n1, n2] will be described in detail below.

(1) Calculation of Observation Likelihood L[t, n] (Sd1)

As described above, the observation likelihood L[t, n] is the likelihood that the unit time interval U[n] of the audio signal X will be reproduced at each time point t on the time axis. The identification unit 331 calculates the observation likelihood L[t, n] for each of the plurality of time points t on the time axis using the following Equation (3).

L[t,n]=Normal{n|F(P[t]),σ(Wb[n],O)>} (3)

Equation (3) means that the observation likelihood L[t, n] follows a normal distribution (Normal) with the number n of the unit time interval U[n] as the random variable. The mean of the probability distribution of the observation likelihood L[t, n] is set to a numerical value F(P[t]) obtained by converting the performance position P[t] estimated by the acquisition unit 32 into the number n of the unit time interval U[n]. In other words, the mean of the probability distribution of the observation likelihood L[t, n] is set in accordance with the performance position P[t]. By the configuration described above, the probability that the reproduction position R[t] will deviate excessively from the performance position P[t] within the analysis time interval q is reduced.

In addition, the variance σ (Wb[n], 0) of the probability distribution of the observation likelihood L[t, n] is expressed as a function with the above-described variation index Wb[n] and a sound generation point group O as variables. The sound generation point group O is a set of time points t that correspond to the performance positions P[t] corresponding to the sound generation points of audio signal X. That is, each time point t constituting the sound generation point group O satisfies the following Equations (4a) and (4b).

P[t]≠P[t−1] (4a)

Wc[F(PI[t])]=1 (4b)

Equation (4a) means that the performance position P[t−1] at time point (t−1) differs from the immediately following performance position P[t] at time point t. Equation (4b) means that the sound generation point index Wc[F(P[t])] in unit time interval U[n] corresponding to the performance position P[t] is the numerical value “1,” which means that it corresponds to a sound generation point.

The variance σ (Wb[n], 0) of the probability distribution related to the observation likelihood L[t, n] is represented by the following Equation (5), for example.

$$σ ( Wb [ n ] , O ) = ε \cdot I [ t ∈ O ] + \frac{1}{Wb [ n ]} I [ t ∉ O ] \qquad ( 5 )$$

The symbol ε in Equation (5) is a sufficiently small positive number (ε<<1). The function I[c] of Equation (5) is a characteristic function (indicator function) that is set to “1” when condition c is satisfied and to “0” when condition c is not satisfied.

As can be understood from Equation (5), if time point t corresponds to a sound generation point (tϵO), the second term on the right side of Equation (5) is eliminated, so that the variance σ (Wb[n], 0) is set to a sufficiently small value F. On the other hand, if time point t does not correspond to a sound generation point, the first term on the right side of Equation (5) is eliminated, so that the variance σ (Wb[n], 0) is set to value 1/Wb[n] corresponding to the variation index Wb[n]. The numerical value F of the variance σ (Wb[n], 0) when time point t corresponds to a sound generation point is less than the numerical value 1/Wb[n] of the variance σ (Wb[n], 0) when time point t does not correspond to a sound generation point. The variance F of the probability distribution when time point t corresponds to a sound generation point is one example of a “first variance,” and the variance 1/Wb[n] of the probability distribution when time point t does not correspond to a sound generation point is one example of a “second variance.”

Therefore, at time point t (tϵO), which corresponds to a sound generation point, the observation likelihood L[t, n] is a local high in the neighborhood of the mean F(P[t]) of the random variable n. In other words, at time point t corresponding to a sound generation point, the probability that the reproduction position R[t] approximates or matches the performance position P[t] is sufficiently higher than the probability that the reproduction position R[t] deviates from the performance position P[t]. Therefore, there is the benefit that the reproduction of audio signal X can easily be made to follow the user's performance of the target musical piece.

It should be noted that when a time interval of audio signal X in which there is a significant variation in the acoustic characteristics is time-stretched on the time axis, the reproduced sound can create the impression of sounding unnatural. On the other hand, a time interval of audio signal X in which the acoustic characteristics are stably maintained can be time-stretched on the time axis without the reproduced sound creating an impression of auditory unnaturalness.

In consideration of the tendency described above, the identification unit 331 of the first embodiment sets the variance σ (Wb[n], 0) of the probability distribution of the observation likelihood L[t, n] when time point t does not correspond to a sound generation point to a numerical value corresponding to the variation index Wb[n], as can be understood from the above-mentioned Equation (5). Specifically, the smaller the variation index Wb[n], the larger the variance σ (Wb[n], 0) is set. In other words, compared to a case in which time point t corresponds to a sound generation point, the probability of identifying a reproduction position R[t] that deviates from the performance position P[t] increases. As described above, the more stably the acoustic characteristics of audio signal X are maintained, the smaller the variation index Wb[n] that is set. Therefore, in a time interval in which the acoustic characteristics of the audio signal X are more stably maintained (i.e., a time interval in which the variation index Wb[n] is smaller), the probability of the reproduction position R[t] deviating from the performance position P[t] increases. The configuration described above realizes the tendency that a time interval of audio signal X in which the acoustic characteristics are stably maintained can be easily time-stretched on the time axis, and that a time interval in which the acoustic characteristics fluctuate unstably cannot be easily time-stretched. Therefore, the reproduced sound can be made to create an audibly natural impression.

(2) Calculation of Transition Probability τ[n1, n2] (Sb)

As described above, the transition probability τ[n1, n2] means the probability that the reproduction position R[t] transitions from unit time interval U[n1] to subsequent unit time interval U[n2] of audio signal X. The identification unit 331 calculates the transition probability τ[n1, n2] for all of the possible combinations of selecting two unit time intervals U[n] (U[n1] and U[n2]) from the N unit time intervals U[1]-U[N] of the audio signal X.

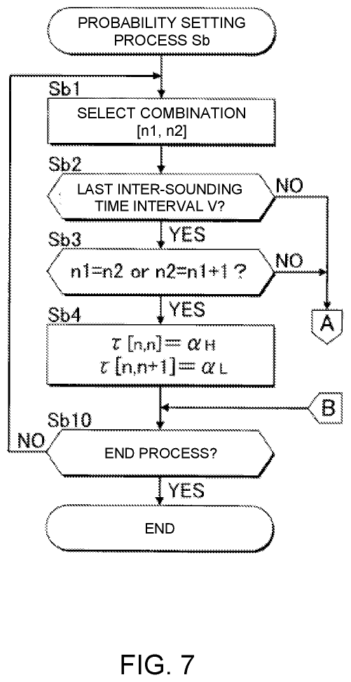

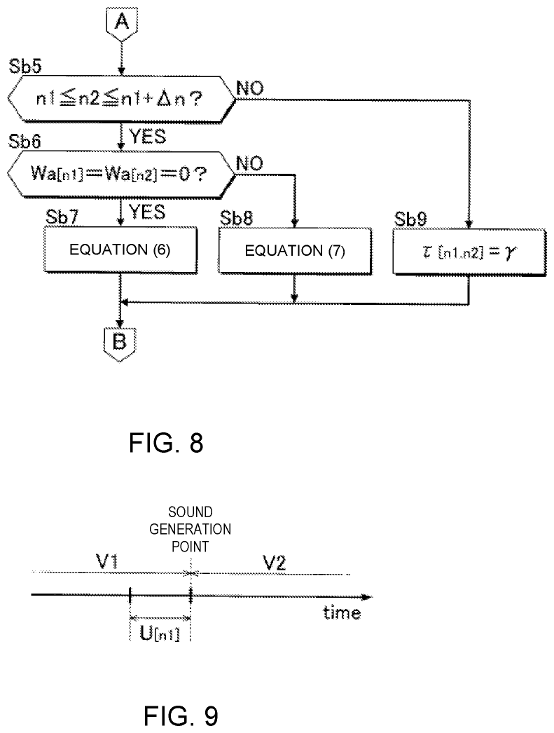

FIGS. 7 and 8 show the specific procedure of the process (hereinafter referred to as “probability setting process”) Sb for the identification unit 331 to calculate the transition probability τ[n1, n2]. When the probability setting process Sb is started, the identification unit 331 selects a combination of two unit time intervals U[n] (U[n1] and U[n2]) from the N unit time intervals U[1]-U[N] of the audio signal X (Sb1).

The identification unit 331 determines whether the unit time interval U[n1] before a transition corresponds to the last unit time interval U[n] of an inter-sounding time interval V (Sb2). The inter-sounding time interval V is a time interval obtained by dividing the audio signal X on the time axis, with each sound generation point as a boundary. FIG. 9 shows two consecutive inter-sounding time intervals V (V1, V2) on the time axis, where it is assumed that the unit time interval U[n1] is located at the end of the inter-sounding time interval V1 (Sb2: YES).

If the pre-transition unit time interval U[n1] is located at the end of the inter-sounding time interval V1 (Sb2: YES), the identification unit 331 determines whether a prescribed condition is satisfied (Sb3). Specifically, the identification unit 331 determines whether a first condition (n1=n2), in which unit time interval U[n1 coincides with unit time interval U[n2], or a second condition, in which the post-transition unit time interval U[n2] is the unit time interval U[n1+1] immediately following the pre-transition unit time interval U[n1], is satisfied. The first condition means that the reproduction position R[t] remains in the last unit time interval U[n] of inter-sounding time interval V1. The second condition means that the reproduction position R[t] transitions from the last unit time interval U[n] of the inter-sounding time interval V1 to a unit time interval U[n+1] in the immediately succeeding inter-sounding time interval V2.

If the first condition or the second condition is satisfied (Sb3: YES), the identification unit 331 sets the transition probability τ[n1, n2] according to the following rules (Sb4). Specifically, if the first condition is satisfied, the identification unit 331 sets the transition probability τ[n1, n2] (n1=n2) to a prescribed value αH. On the other hand, if the second condition is satisfied, the identification unit 331 sets the transition probability τ[n1, n2] (n2=n1+1) to a prescribed value αL. The prescribed value αH and the prescribed value αL are prescribed positive numbers. The prescribed value αH is set to a numerical value that is sufficiently larger than the prescribed value αL (αH>>αL). For example, the prescribed value αH is set to a positive number that is less than or equal to “1” and that is sufficiently close to “1,” whereas the prescribed value αL is set to a numerical value obtained by subtracting the prescribed value αH from “1” (αL=1−αH).

As can be understood from the foregoing explanation, the transition probability τ[n1, n2] (=αH) of the reproduction position R[t] remaining in the last unit time interval U[n1] of the inter-sounding time interval V1 sufficiently exceeds the transition probability τ[n1, n2] (αL) of the reproduction position R[t] transitioning from the last unit time interval U[n1] of the inter-sounding time interval V1 to the first unit time interval U[n2] of the immediately succeeding inter-sounding time interval V1. By the configuration described above, since a transition of the reproduction position R[t] across sound generation points of the audio signal X is suppressed, the probability of the acoustic components corresponding to one sound generation point being repeatedly reproduced numerous times is reduced. For example, the probability of a singing voice that is the reproduced sound of the audio signal X being perceived by the listener as stuttering is reduced. In other words, the reproduced sound can be made to create an audibly natural impression. If the reproduction position R[t] remains in one unit time interval U[n] continuously, the volume of the reproduced sound of audio signal X can be decreased over time.

On the other hand, if the unit time interval U[n1] does not correspond to the last unit time interval U[n1] of the inter-sounding time interval V (Sb2: NO), or if the prescribed condition is not satisfied (Sb3: NO), the identification unit 331 determines whether the post-transition unit time interval U[n2] is within a prescribed range with respect to the pre-transition unit time interval U[n1] on the time axis, as shown in FIG. 8 (Sb5). Specifically, the identification unit 331 determines whether the unit time interval U[n2] is located within a range of prescribed length Δn, starting at unit time interval U[n1]. If a number n2 of the post-transition unit time interval U[n2] is greater than or equal to the number n1 and less than or equal to (n1+Δn) (n1≤n2≤n1+Δn), the result of this determination is affirmative. If the number n2 of the unit time interval U[n2] exceeds the prescribed value (n1+Δn), this means that the reproduction position R[t] moves backward from unit time interval U[n1] by an excessive amount.

If the unit time interval U[n2] is within the prescribed range (Sb5: YES), the identification unit 331 determines whether audio signal X is silent in both the pre-transition unit time interval U[n1] and the post-transition unit time interval U[n2] (Sb6). In other words, it is determined whether both the sound occurrence index Wa[n1] and the sound occurrence index Wa[n2] have a numerical value of “0,” indicating silence. If both the unit time interval U[n1] and unit time interval U[n2] contain silence (Sb6: YES), the identification unit 331 sets the transition probability τ[n1, n2] with the following Equation (6) (Sb7).

τ[n1,n2]=β·I[|n1−n2|<τ0] (6)

The symbol 3 of Equation (6) indicates a prescribed positive number, and the symbol τθ indicates a prescribed threshold value. As can be understood from Equation (6), in the case that an absolute value |n1−n2| of the difference between the number n1 and the number n2 is below the threshold value τθ, the transition probability τ[n1, n2] is set to the prescribed value β. On the other hand, if the absolute value |n1−n2| is greater than or equal to the threshold value τθ, the transition probability τ[n1, n2] is set to “0.” As can be understood from the foregoing explanation, when the transition amount |n1−n2| on the time axis is in a range that is below the threshold value τθ, a transition of the reproduction position R[t] is allowed, with the prescribed value β as the transition probability τ[n1, n2]. On the other hand, a transition of the reproduction position R[t] in which the transition amount |n1−n2| on the time axis exceeds the threshold value τθ is prohibited (τ[n1, n2]=0).

On the other hand, if the audio signal X contains sound in unit time interval U[n1] and/or unit time interval U[n2] (Sb6: NO), the identification unit 331 sets the transition probability τ[n1, n2] with the following Equation (7) (Sb8).

τ[n1,n2]=Normal{n1−n2|P0,P0/Wb[n])} (7)

Equation (7) means that the transition probability τ[n1, n2] follows a normal distribution (Normal) with the difference (n1−n2) between numbers n1 and the n2 as the random variable. The difference (n1−n2) corresponds to the amount of movement of the reproduction position R[t] between time point (t−1) and time point t, i.e., the speed of movement of the reproduction position R[t].

The mean of the probability distribution of the transition probability τ[n1, n2] is set to the above-mentioned standard speed Pθ. The standard speed Pθ corresponds to a standard reproduction speed of audio signal X and is set to a prescribed positive number. Specifically, the standard speed Pθ means the amount of change of the number n between time point (t−1) and time point t, when the reproduction position R[t] of audio signal X moves on the time axis at a standard speed. For example, the standard speed Pθ is set to the ratio of the hop length Hn to the hop length Ht (Pθ=Hn/Ht).

The variance of the probability distribution of the transition probability τ[n1, n2] is set to a numerical value Pθ/Wb[n1] corresponding to the variation index Wb[n]. Specifically, the smaller the variation index Wb[n1], the larger the variance Pθ/Wb[n1] of the probability distribution that is set. In other words, the smaller the variation index Wb[n], the greater the probability that the movement speed of the reproduction position R[t] will deviate from the standard speed Pθ. As described above, the more stably the acoustic characteristics of the audio signal X is maintained, the smaller the variation index Wb[n] that is set. Therefore, for example, in a time interval in which the acoustic characteristics of the audio signal X are stably maintained (that is, a time interval in which the variation index Wb[n] is small), the variance Pθ/Wb[n1] of the probability distribution of the transition probability τ[n1, n2] is set to a large numerical value, and thus, the movement speed of the reproduction position R[t] is allowed to deviate from the standard speed Pθ. On the other hand, in a time interval in which the acoustic characteristics of the audio signal X fluctuate unstably (that is, a time interval in which the variation index Wb[n] is large), the variance Pθ/Wb[n1] of the probability distribution of the transition probability τ[n1, n2] is set to a small numerical value, and thus, the movement speed of the reproduction position R[t] is maintained at a speed close to the standard speed Pθ. In other words, a time interval of the audio signal X in which the acoustic characteristics are stably maintained can be easily time-stretched on the time axis, and a time interval in which the acoustic characteristics fluctuate unstably cannot be easily time-stretched. Therefore, the reproduced sound can be made to create an audibly natural impression.

The transition probability τ[n1, n2] (=(3) when audio signal X is silent in both unit time interval U[n1] and unit time interval U[n2] (Wa[n1]=Wa[n2]=0) is greater than the transition probability τ[n1, n2] when audio signal X contains sound in unit time interval U[n1] and/or unit time interval U[n2]. Under the conditions described above, a transition of the reproduction position R[t] of audio signal X during a silent time interval is more likely to occur than a transition of the reproduction position R[t] between a sound-occurring time interval and a silent time interval, or a transition of the reproduction position R[t] within a sound-occurring time interval. Therefore, compared to a configuration in which a transition of the reproduction position R[t] occurs frequently within a sound-occurring time interval, the reproduced sound can be made to create an audibly natural impression.

If unit time interval U[n2] is not within a prescribed range with respect to unit time interval U[n1] (Sb5: NO), the identification unit 331 sets the transition probability τ[n1, n2] to a prescribed value γ (Sb9). The prescribed value γ is set to a positive number that is sufficiently smaller than the prescribed value β in Equation (6). In other words, the reproduction position R[t] is allowed to transition to a unit time interval U[n2] that is outside of the prescribed range from unit time interval U[n1], although with a lower probability (prescribed value γ) than a transition of the reproduction position R[t] within said range.

When the transition probability τ[n1, n2] related to the current combination (U[n1], U[n2]) is calculated by the above-described processes (Sb4, Sb7, Sb8, Sb9), the identification unit 331 determines whether the transition probability τ[n1, n2] has been set for all combinations obtained by the selection of two unit time intervals from the N unit time intervals U[1]-U[N] of audio signal X, as shown in FIG. 7 (Sb10). If there is a transition probability τ[n1, n2] that is not set (Sb10: NO), identification unit 331 causes the process to proceed to Step Sb1. In other words, two unit time intervals U[n] (U[n1], U[n2]) for which the transition probability τ[n1, n2] has not been set are newly selected (Sb1), and the transition probability τ[n1, n2] related to this combination is set (Sb2−Sb9). On the other hand, if all of the transition probabilities τ[n1, n2] have been set (Sb10: YES), the identification unit 331 ends the probability setting process Sb.

### B: Second Embodiment

In a configuration in which the volume of the sound of audio signal X reproduced by the sound output device 23 and the volume of the sound emitted by the keyboard instrument 10 differ, it may be impossible to generate a sense of musical unity between the two. In consideration of such circumstances, in the second embodiment, the volume of the reproduction sound of the audio signal X (hereinafter referred to as “reproduction volume”) is linked to the intensity (hereinafter referred to as the “operating intensity”) of the user's operation of the keyboard instrument 10. Specifically, the reproduction unit 332 controls the reproduction volume of the audio signal X in accordance with the user's operating intensity. The configurations and operations of elements other than the reproduction unit 332 are the same as those in the first embodiment. Therefore, the same effects as those of the first embodiment can be realized by the second embodiment.

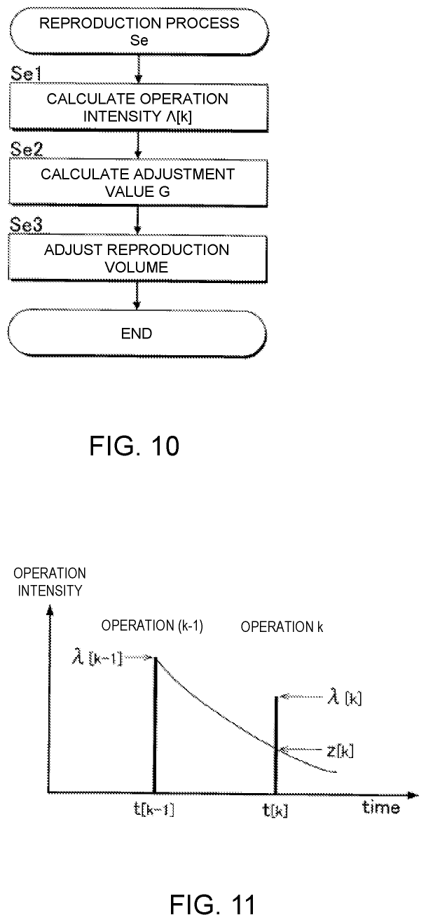

FIG. 10 is a flowchart showing the specific procedure of a process (hereinafter referred to as “reproduction process”) Se executed by the reproduction unit 332 in the second embodiment. When the reproduction process Se is initiated, the reproduction unit 332 calculates an operating intensity Λ[k] with the following Equation (8a) and Equation (8b) (Se1). Operating intensity Λ[k] is a numerical value (velocity) specified by the performance data D.

Λ[k]=max{z[k],λ[k]} (8a)

z[k]=exp{−a(t[k]−t[k−1])}−λ[k−1] (5b)

FIG. 11 is a diagram explaining operating intensity Λ[k]. The symbol k in Equation (8a) and Equation (8b) is a number that identifies each operation (specifically, key depression) of the keyboard instrument 10. The symbol t[k] indicates the time point at which an operation k occurs. As shown in FIG. 11, a case is assumed in which an operation (k−1) with operating intensity λ[k−1] occurs at time point t[k−1], and an operation k with an operating intensity λ[k] occurs at time point t[k] after time point t[k−1]. The operation k is, for example, a key depression immediately following operation (k−1). Time point t[k−1] is one example of a “first time point,” and operation (k−1) is one example of a “first operation.” In addition, time point t[k] is one example of a “second time point,” and operation k is one example of a “second operation.”

As can be understood from Equation (8a), the reproduction unit 332 selects the larger (max) of an operating intensity z[k] and the operating intensity λ[k] as the operating intensity Λ[k] at time point t[k]. As can be understood from Equation (8b), the operating intensity z[k] is the intensity obtained by lowering the operating intensity λ[k−1] of the operation (k−1) over time from time point t[k−1] to time point t[k]. The symbol λ of Equation (8b) is a prescribed positive number indicating the degree to which the operating intensity λ[k−1] is reduced with time. The operating intensity z[k] is one example of a “first intensity,” and the operating intensity λ[k] is one example of a “second intensity.”

When the operating intensity Λ[k] is calculated by the calculation described above, the reproduction unit 332 calculates an adjustment value G in accordance with the operating intensity Λ[k] (Se2). The adjustment value G is a coefficient (gain) by which the portion Y of audio signal X to be reproduced is multiplied. Specifically, the reproduction unit 332 calculates the adjustment value G with the following Equation (9).

$$G = 0.3 + 0.7 {\{ 1 + exp ( \frac{Λ [ k ] - 64}{30} ) \}}^{- 1} \qquad ( 9 )$$

As can be understood from Equation (9), the adjustment value G changes in accordance with the operating intensity Λ[k] within a range between a minimum value 0.3 and a maximum value 1. Specifically, the larger the operating intensity Λ[k], the larger the adjustment value G that is set. The reproduction unit 332 uses the adjustment value G to adjust the reproduction volume of the audio signal X (Se3). Specifically, the reproduction unit 332 multiplies the portion Y of audio signal X corresponding to the reproduction position R[t] by the adjustment value G. As can be understood from the foregoing explanation, the reproduction unit 332 controls the reproduction volume of the audio signal X in accordance with the operating intensity Λ[k]. A specific example of the reproduction process Se in the second embodiment follows.

In the second embodiment, the reproduction volume of audio signal X is controlled in accordance with the larger of operating intensity z[k], which is obtained by reducing the operating intensity λ[k−1] of the operation (k−1) with time up to time point t[k], and the operating intensity λ[k] of the operation k at said time point t[k] (that is, the operating intensity Λ[k]). Therefore, for example, even if operating intensity λ[k] is sufficiently smaller than operating intensity λ[k−1], if operating intensity Λ[k], which is obtained by reducing the operating intensity λ[k−1] with time up to time point t[k], is sufficiently large, the reproduction volume of audio signal X is maintained sufficiently. Therefore, compared to a configuration in which the reproduction volume is controlled in accordance with the operating intensity λ[k] of each operation, the reproduction volume can be controlled appropriately for the user's performance.

### C: Modified Example

Specific modified embodiments to be added to each of the aforementioned embodiment examples are shown below. Two or more embodiments arbitrarily selected from the following examples can be appropriately combined insofar as they are not mutually contradictory.

(1) In each of the above-described embodiments, the keyboard instrument 10 was used as an example, but the type of musical instrument with which the user performs the target musical piece is not limited to the keyboard instrument 10. For example, any type of musical instrument, such as a string instrument, a wind instrument, or a percussion instrument, can be used for the user's performance of the target musical piece. For example, the acquisition unit 32 analyzes performance data D supplied from an arbitrary musical instrument to estimate the performance position P[t]. In addition, the device for generating performance data D can be a device other than a musical instrument. For example, any type of device that accepts user performance instructions, e.g., an information device such as a smartphone or a tablet terminal, or an operation device such as a keyboard, can be used instead of the above-described keyboard instrument 10.

In each of the embodiments described above, instruction data representing user performance instructions was used as an example of performance data D, but the type of performance data D used for the analysis of the performance (estimation of the performance position P[t]) is not limited to instruction data. For example, acoustic data representing the waveform of the sound produced by the user's performance can be used as performance data D to analyze the performance.

(2) In the embodiments described above, the reproduction position R[t] is identified using part of the processing time interval Q as the analysis time interval q, but the identification unit 331 can identify the reproduction position R[t] using the entire processing time interval Q as the analysis time interval q. In other words, time points t2 and t3 can coincide on the time axis, and the distinction between the processing time interval Q and the analysis time interval q is omitted.

(3) In the embodiments described above, the variance σ (Wb[n], 0) in the probability distribution of the observation likelihood L[t, n] is changed in accordance with the variation index Wb[n], but the variance of the probability distribution of the observation likelihood L[t, n] can be set to a prescribed value that does not depend on the variation index Wb[n]. Similarly, in the embodiments described above, the variance Pθ/Wb[n1] in the probability distribution of the transition probability τ[n1, n2] is changed in accordance with the variation index Wb[n], but the variance of the probability distribution of the transition probability τ[n1, n2] can be set to a prescribed value that does not depend on the variation index Wb[n].

(4) The movement speed of the reproduction position R[t] can be limited to a prescribed range. For example, if the amount of movement of reproduction position R[t] between time points (t−1) and t exceeds a prescribed upper limit, the identification unit 331 sets the reproduction position R[t] to a numerical value that corresponds to this upper limit value. On the other hand, if the amount of movement of reproduction position R[t] between time points (t−1) and t is less than a prescribed lower limit, the identification unit 331 sets reproduction position R[t] to a numerical value corresponding to this lower limit value. By the configuration described above, excessive deviation between performance position P[t] and reproduction position R[t] can be suppressed.

(5) If the difference between the performance position P[t] and the reproduction position R[t] exceeds a prescribed threshold value, the identification unit 331 can initialize the reproduction position R[t] to the performance position P[t]: (R[t]=P[t]). By the configuration described above, excessive deviation between performance position P[t] and reproduction position R[t] can be suppressed. In addition, the reproduction position R[t] can be changed at the standard speed Pθ within a prescribed time interval from the point in time at which the reproduction position R[t] is initialized to the performance position P[t]. In other words, reproduction position R[t] need not reflect performance position P[t] within that time interval.

(6) In the embodiments described above, the analysis unit 31 generates index W[n] by analyzing audio signal X stored in the storage device 22, but in a configuration in which index W[n] pertaining to audio signal X is stored in the storage device 22 in advance, the analysis unit 31 can be omitted. For example, in a configuration in which index W[n]pertaining to audio signal X is provided to the signal processing system 20 from an external device, the analysis unit 31 is omitted.

(7) As indicated in the examples described above, various conditions (hereinafter referred to as “search conditions”) are applied to path search Sd2 in the aforementioned embodiments. Search conditions are conditions set in accordance with the characteristics of audio signal X. Search conditions include, in addition to the constraint conditions pertaining to reproduction position R[t], the numerical values of variables applied to path search Sd2. As shown above, a constraint condition is a condition in which reproduction position R[t1] at time point t1 of analysis time interval q is fixed to performance position P[t1] at time point t1 and reproduction position R[t2] at time point t2 of analysis time interval q is fixed to performance position P[t2] of time point t2. In addition, examples of search conditions pertaining to variables applied to path search Sd2 include indexes, such as observation likelihood L[t, n], transition probability τ[n1, n2], and variation index Wb[t]. In other words, any variable applicable to path search Sd2 is encompassed in the concept of search conditions.

(8) In the embodiments described above, an example was shown in which the acquisition unit 32 identifies user performance position P[t] of the target musical piece, but the information used for identifying reproduction position R[t] is not limited to performance position P[t]. For example, performance positions P[t] can be replaced with positions that change within the target musical piece in accordance with operations of an operating device, such as a mouse or touch panel. For example, performance positions P[t] can be replaced with positions within the target musical piece that are indicated and changed by the user. As can be understood from the foregoing examples, the position used to identify reproduction position R[t] can be comprehensively expressed as a position that changes on the time axis within the target musical piece in response to the user's actions (hereinafter referred to as an “indicated position”). The performance positions P[t] in the embodiments described above and the positions indicated by the user by operations of an operating device are specific examples of indicated positions. For example, a DJ controller, in which a disk-shaped turntable is rotated in response to a user operation, can be used as the operating device used by the user to indicate the indicated position. Here, the acquisition unit 32 identifies the indicated position in accordance with the angle of rotation of the turntable.

(9) In the embodiments described above, audio signal X representing the performance sounds of the target musical piece is time-stretched in accordance with the user's performance of the keyboard instrument 10, but the time series signal to be time-stretched is not limited to audio signal X. For example, a video signal representing images associated with the target musical piece can be time-stretched on the time axis in response to the user's performance. The video signal represents, for example, moving images to be displayed in parallel with the performance of the target musical piece.

In a configuration in which a video signal is processed, the estimation of performance position P[t] by the acquisition unit 32 and the identification of reproduction position R[t] by the identification unit 331 are the same as those of the embodiments described above. The reproduction unit 332 causes a display device to display the portion of the video signal that corresponds to reproduction position R[t]. Variation index Wb[n] calculated by the analysis unit 31 by analyzing the video signal is, for example, a variable that represents the degree of variation of the video characteristics of the video signal. One such video characteristic is, for example, image brightness. In addition, an index (motion vector) representing the changes in consecutive images on the time axis can be calculated by the analysis unit 31 as the variation index Wb[n].

As can be understood from the foregoing explanation, signals to be processed by the signal processing system 20 are comprehensively expressed as time series signals (for example, audio signal X or video signal) representing audio or video pertaining to the target musical piece. In addition, the reproduction unit 332 is an element that causes the reproduction device to reproduce the portion of the time series signal that corresponds to reproduction position R[t]. The reproduction device includes the sound output device 23 that reproduces the sound represented by audio signal X or the display device (display) that displays the video represented by the video signal.

(10) The signal processing system 20 can be realized by a server device that communicates with information terminals, such as smartphones or tablet terminals. For example, performance data D generated by the keyboard instrument 10 connected to an information device are transmitted from the information device to the signal processing system 20. In the signal processing system 20, the estimation of performance position P[t] by the acquisition unit 32 and the identification of reproduction position R[t] by the identification unit 331 are performed in the same manner as in the embodiments described above. The reproduction unit 332 transmits the portion Y of audio signal X that corresponds to reproduction position R[t] to the information device. The information device is provided with sound output device 23 that reproduces portion Y received from the signal processing system 20. The same effects as those of the above-described embodiments can be realized with the configuration described above. An operation in which the reproduction unit 332 transmits the portion Y of audio signal X to the information device is expressed as an operation in which the information device is made to reproduce the aforementioned portion.

(11) As described above, the functions of the signal processing system 20 according to the embodiments described above are realized by the collaborative interactions between one or more processors that constitute the control device 21 and a program stored in the storage device 22. The program according to the present disclosure can be provided in the form stored in a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage medium that stores the program in the distribution device corresponds to the non-transitory storage medium.

### D: Addendum

The following configurations, for example, can be understood from the foregoing embodiments examples.

A signal processing system according to one aspect (Aspect 1) of this disclosure is a signal processing system for causing a reproduction device to reproduce time series signals that follow the reproduction of a musical piece, comprising an acquisition unit for acquiring a position indicated by a user in the reproduction of the musical piece, and a control unit for executing time stretching of the time series signal in accordance with the indicated position. According to the embodiment described above, the time series signal is stretched or shrunk (time stretch) in accordance with the user's indicated position in the reproduction of the musical piece. Therefore, the reproduction of the time series signal can be made to follow the user's instruction.

The “indicated position” is the position in the musical piece indicated by the user. Specifically, a position that changes within the musical piece in response to the actions by the user is an example of an “indicated position.” A typical example of an “indicated position” is, for example, the position on the time axis (performance position) at which the user is performing in the musical piece. However, the actions of the user reflected in the indicated position are not limited to “performing.” For example, a configuration in which the “indicated position” changes in accordance with an operation (another example of an “action”) on an operating device, such as a mouse or a touch panel, is also conceivable. In addition to a position currently indicated by the user, an “indicated position” also includes the position that the user is expected to indicate in the future.

A “time series signal” is a time domain signal for reproduction. Specifically, a “time series signal” is a time domain signal that represents audio or video, for example. More specifically, an audio signal representing the performance sounds of a musical piece or a video signal representing the video to be displayed in parallel with the performance of a musical piece is a typical example of a “time-series signal.” Therefore, the “reproduction device” is, for example, the sound output device 23 that emits sound represented by the audio signal, or a display device that displays the video represented by the video signal.

The performance sound represented by the “audio signal” includes, in addition to the musical sound produced by a musical instrument by performance, voice (singing voice) produced by a singer. The performance sound represented by the audio signal and the performance sound produced by a user's performance have a relationship of correspondence to the same musical piece, but the specific relationship between the two is arbitrary. For example, the performance part of the performance sound represented by the audio signal and the performance part played by the user can be different or the same. In other words, assuming a case in which the user performs one or more performance parts from among a plurality of performance parts of a musical piece, the audio signal represents the performance sound of the one or more performance parts, or the performance sound of one or more performance parts other than the aforementioned one or more performance parts.

In a specific example (Aspect 2) of Aspect 1, the time series signal is a signal representing audio or video, the acquisition unit acquires a plurality of indicated positions over time, and the control unit performs time stretching by a path search to which is applied two or more different indicated positions from among the plurality of indicated positions, and a search condition corresponding to characteristics of the time series signal. The “search condition” is set in accordance with the characteristics of the time series signal and is applied to the path search. The “search condition” includes, in addition to the constraint conditions related to the reproduction position (for example, Aspect 7), numerical values of variables applied to the path search (for example, Aspects 8, 10, and 11).

In a specific example (Aspect 3) of Aspect 1 or 2, the reproduction of the musical piece is a performance of the musical piece by the user. By the aspect described above, the reproduction of the time series signal can be made to follow the user's performance of the musical piece.

The term “performance” refers to actions by the user that cause a progression of the music, and is a broad concept that includes not only actions that cause, by operations of a device such as a musical instrument, the musical instrument to produce sound (performance as narrowly defined), but also actions by the user to sing a musical piece. The indicated position (performance position) is identified by analysis of the performance of the user. An “analysis of the performance” is realized by analyzing the performance data that represent the user's performance, for example. The performance data are instruction data (for example, MIDI data) representing the user's performance instructions, or, audio data (for example, sample sequence) representing the audio waveforms produced by the user's performance.

In a specific example (Aspect 4) of Aspect 1, the control unit includes an identification unit for identifying the reproduction position corresponding to the indicated position of the time series signal, and a reproduction unit for causing a reproduction device to reproduce a portion of the time series signal that corresponds to the reproduction position to execute time stretching. By the aspect described above, the reproduction device is caused to reproduce the portion of the time series signal that corresponds to the reproduction position, thereby realizing the time stretching of the time series signal that follows the changes in the indicated position. The “reproduction position” is a position on the time axis of the time series signal.

In a specific example (Aspect 5) of Aspect 4, the acquisition unit sequentially identifies the indicated position for each of a plurality of time points on a time axis; in each of a plurality of processing time intervals on the time axis; the identification unit executes a path search, to which two or more indicated positions respectively identified for two or more time points within the processing time interval from among the plurality of time points, and a search condition corresponding to the characteristics of the time series signal are applied, thereby identifying a time series of two or more reproduction positions corresponding to different time points within at least a part of the processing time interval; and the reproduction unit causes the reproduction device to reproduce portions of the time series signal that respectively correspond to the two or more reproduction positions. By the aspect described above, since the path search for identifying the time series of two or more reproduction positions is executed for each processing time interval on the time axis, even if the movement speed of the indicated positions fluctuate irregularly, it is possible to identify the reproduction positions that follow the user's instructions with high accuracy.

In a specific example (Aspect 6) of Aspect 5, the processing time interval is a time interval between a first time point, from among the plurality of time points, and a second time point located after the first time point, and at least a portion of the processing time interval is an analysis time interval from the first time point to a third time point between the first time point and the second time point. By the aspect described above, the time series of two or more reproduction positions within the analysis time interval from the first time point to the third time point is estimated in accordance with the time series of indicated positions within the processing time interval from the first time point to the second time point. Therefore, it is possible to reduce the influence of estimation error (noise) of the indicated positions in a time interval (for example, a time interval from the third time point to the second time point) in the vicinity of the end point of the processing time interval. In other words, the reproduction positions can be more appropriately identified compared to a configuration in which the time series of indicated positions within the processing time interval is used to identify the time series of reproduction positions over the entire processing time interval.

In a specific example (Aspect 7) of Aspect 6, the search conditions include a condition for fixing the reproduction position at the first time point to the indicated position at the first time point, and fixing the reproduction position at the second time point to the indicated position at the second time point. By the aspect described above, the reproduction position at the first time point is fixed to the indicated position at the first time point, and the reproduction position at the second time point is fixed to the indicated position at the second time point. Therefore, the probability of the reproduction position excessively deviating from the indicated position within the analysis time interval is reduced.

In a specific example (Aspect 8) of Aspect 5, the search conditions include an observation likelihood at each of the plurality of time points, wherein the observation likelihood is the probability that each of a plurality of unit time intervals, which are obtained by dividing the time series signal on a time axis, corresponds to the reproduction position at a given time point, and wherein a probability distribution of the observation likelihood is defined by an average corresponding to the indicated position. In the aspect described above, the mean of the probability distribution of the observation likelihood applied to the path search is set in accordance with the indicated position. Therefore, the probability of the reproduction position deviating s excessively from the indicated position within the analysis time interval is reduced.

In a specific example (Aspect 9) of Aspect 8, the time series signal is an audio signal representing the performance sound of a musical piece, the probability distribution of the observation likelihood at a time point at which the indicated position corresponds to a sound generation point of the audio signal, from among the plurality of time points, is defined by a first variance, and the probability distribution of the observation likelihood at a time point at which the indicated position does not correspond to a sound generation point of the audio signal, from among the plurality of time points, is defined by a second variance that is greater than the first variance. By the aspect described above, the variance (first variance) of the probability distribution used for identification of the reproduction positions at time points corresponding to the sound generation points of the audio signal is smaller than the variance (second variance) of the probability distribution used for the identification of the reproduction positions for time points that do not correspond to sound generation points. Therefore, at a time point that corresponds to a sound generation point, the observation likelihood becomes a local high in the vicinity of a numerical value corresponding to the indicated position. In other words, at the time point that corresponds to a sound generation point, the probability of the reproduction position approximately or precisely coinciding with the indicated position is high as compared with the probability of the reproduction position deviating from the indicated position. Therefore, there is the benefit that the reproduction of the audio signal can easily be made to follow the user's performance.

In a specific example (Aspect 10) of Aspect 8 or 9, the search conditions include a transition probability that is set for each combination of two unit time intervals, from among the plurality of unit time intervals obtained by dividing the time-series signal on the time axis, and the represents the probability of the reproduction position transitioning between the two unit time intervals. By the aspect described above, the variance pertaining to the probability distribution of the observation likelihood is set in accordance with the variation index of the time series signal. For example, the variance is set to a small numerical value at a point in time in the time series signal at which the characteristics fluctuate unstably; as a result, the reproduction position approximately coincides with the indicated position. On the other hand, the variance is set to a large numerical value at a point in time in the time series signal at which the variation of the characteristics is small; as a result, the identification of a reproduction position that deviates from the indicated position is allowed. In other words, the reproduced sound can be made to create an audibly natural impression.

The “variation index” is an arbitrary index corresponding to the degree of variation of the characteristics of the time series signal. The degree of variation of the characteristics is, for example, the frequency or amount of variation of a given characteristic. Therefore, the variation index is, in other words, an index of the stability or instability of the characteristics of the time series signal. The variation index pertaining to an audio signal represents the degree of variation of the acoustic characteristics, such as the fundamental frequency or the frequency characteristics (for example, the amplitude spectrum or MFCC). The variation index related to a video signal represents the degree of variation of the video characteristics, such as brightness.

In a configuration in which the variation index is set to a large numerical value, the degree of variation of a given characteristic will be high (that is, the characteristic fluctuates unstably on the time axis), where the variation index is an expression of the ease with which a given characteristic fluctuates. On the other hand, in a configuration in which the variation index is set to a large numerical value, the degree of variation of a given characteristic is small (that is, the characteristic is stably maintained on the time axis), where the variation index is an expression of the difficulty with which a given characteristic fluctuates.

In a specific example (Aspect 11) of any one of Aspects 4 to 10, the search conditions include a transition probability that is set for each combination of two unit time intervals from among the plurality of unit time intervals obtained by dividing the time series signal on the time axis, and that represents the probability of the reproduction position transitioning between the two unit time intervals. By the aspect described above, the time series of the reproduction positions can be appropriately identified by the path search to which is applied the transition probability for each combination of two unit time intervals of the time series signal.

The “two unit time intervals” include, in addition to two different unit time intervals on the time axis, the same unit time intervals on the time axis. If the two unit time intervals are different, the transition probability means the probability of the reproduction position moving on the time axis. On the other hand, if the two unit time intervals are the same, the transition probability means the probability of the reproduction position remaining in one unit time interval on the time axis.

In a specific example (Aspect 12) of Aspect 11, the time series signal is an audio signal representing the performance sound of a musical piece, and the transition probability (first transition probability) when the audio signal is silent in both of the two unit time intervals is greater than the transition probability (second transition probability) when the audio signal contains sound in one or both of the two unit time intervals. By the aspect described above, a transition of the reproduction position of the audio signal in a silent time interval is more likely to occur compared with a transition of the reproduction position between a sound-occurring time interval and a silent time interval, or a transition of the reproduction position within a sound-occurring time interval. Therefore, compared to a configuration in which transition of the reproduction position occurs frequently within the sound-occurring time interval, the reproduced sound can be made to create an audibly natural impression.

In a specific example (Aspect 13) of Aspect 12, the probability distribution of the transition probability when the audio signal contains sound in one or both of the two unit time intervals is defined by a mean that is set to a prescribed value, and a variance that corresponds to a variation index representing the degree of variation in the acoustic characteristics of the audio signal. In the aspect described above, the variance of the probability distribution of the transition probability is set in accordance with the variation index of the audio signal. For example, in a time interval of the audio signal in which the acoustic characteristics are stably maintained, the variance of the probability distribution of the transition probability is set to a large numerical value; as a result, the movement speed of the reproduction position is allowed to deviate from a prescribed value. On the other hand, in a time interval of the audio signal in which the acoustic characteristics fluctuate unstably, the variance of the probability distribution of the transition probability is set to a small numerical value; as a result, the movement speed of the reproduction position approaches the prescribed value. In other words, a time interval of the audio signal in which the acoustic characteristics are stably maintained can be easily time-stretched on the time axis, and a time interval in which the acoustic characteristics fluctuate unstably cannot be easily time-stretched. Therefore, the reproduced sound can be made to create an audibly natural impression.

In a specific example (Aspect 14) of any one of Aspects 11 to 13, the transition probability of the reproduction position remaining at the last time point of a first inter-sounding time interval, from among a plurality of inter-sounding time intervals obtained by dividing the audio signal on the time axis by a plurality of sound generation points, is greater than the transition probability of the reproduction position transitioning from the last time point to a time point within a second inter-sounding time interval immediately after the first inter-sounding time interval. In the aspect described above, since a transition of the reproduction position across sound generation points is suppressed, the probability of the acoustic components corresponding to a single sound generation point being repeatedly reproduced numerous times is reduced. In other words, the reproduced sound can be made to create an audibly natural impression.

In a specific example (Aspect 15) of any one of Aspects 4 to 14, the indicated position is a performance position estimated by the acquisition unit analyzing the user's performance of the musical piece. By the aspect described above, the user's performance position of the musical piece is identified as the indicated position. Therefore, it is possible to cause the reproduction of the time-series signal by the reproduction device follow the user's performance of the musical piece.

In a specific example (Aspect 16) of Aspect 15, when the first operation occurs at a first time point in the performance and a second operation occurs at a second time point after the passage of the first time point, the reproduction unit selects, as the operating intensity at the second time point, the larger (i.e., the maximum value) of a first intensity obtained by reducing the intensity of the first operation over time from the first time point to the second time point, and a second intensity of the second operation, and controls the volume of the reproduced sounds of the time series signal in accordance with the operating intensity. In the aspect described above, the volume of the reproduction sound of the audio signal is controlled in accordance with the maximum value (control value) of a plurality of intensities, including a first intensity obtained by reducing the intensity of the first operation over time to the second time point, and a second intensity of the second operation at the second time point. Therefore, for example, even if the second intensity is sufficiently smaller than the first intensity, if the first intensity obtained by reducing the first intensity over time to the second time point is sufficiently large, the volume of the reproduction sound is sufficiently maintained. Therefore, compared to a configuration in which the volume of the reproduction sound is controlled in accordance with the intensity for each operation, the volume of the reproduction sound can be appropriately controlled with respect to the user's performance.

A signal processing method according to one aspect (Aspect 17) of this disclosure is a method for causing a reproduction device to reproduce time series signals that follow the reproduction of a musical piece, comprising acquiring a position indicated by the user in the reproduction of the musical piece, and executing time stretching of the time series signal in accordance with the indicated position.

In a specific example (Aspect 18) of Aspect 17, the time series signal is a signal representing audio or video; in acquiring the indicated position, a plurality of indicated positions are obtained with time, and in the time stretching, the time stretching is executed by a path search to which is applied two or more different indicated positions from among the plurality of indicated positions, and a search condition corresponding to characteristics of the time series signal. The reproduction of a musical piece is, for example, the performance of the musical piece by the user.

A program according to one aspect (Aspect 20) of this disclosure is a program for causing a reproduction device to reproduce time series signals that follow the reproduction of a musical piece and that causes a computer to function as an acquisition unit for acquiring user-indicated positions in the reproduction of the musical piece, and a control unit for executing time stretching of the time series signals in accordance with the indicated positions.

What is claimed is:

1. A signal processing system for causing a reproduction device to reproduce a time series signal that follows reproduction of a musical piece, the signal processing system comprising:
an electronic controller including at least one processor, the electronic controller being configured to execute a plurality of units including
an acquisition unit configured to acquire an indicated position indicated by a user in the reproduction of the musical piece, and
a control unit configured to execute time stretching of the time series signal in accordance with the indicated position.

2. The signal processing system according to claim 1, wherein
the time series signal is a signal representing audio or video,
the acquisition unit is configured to acquire a plurality of indicated positions over time, and
the control unit is configured to execute the time stretching by a path search to which two or more different indicated positions from among the plurality of indicated positions, and a search condition in accordance with characteristics of the time series signal are applied.

3. The signal processing system according to claim 1, wherein
the reproduction of the musical piece is the user's performance of the musical piece.

4. The signal processing system according to claim 1, wherein
the control unit includes
an identification unit configured to identify a reproduction position of the time series signal, and the reproduction position corresponds to the indicated position, and
a reproduction unit configured to cause the reproduction device to reproduce a portion of the time series signal to execute the time stretching, and the portion corresponds to the reproduction position.

5. The signal processing system according to claim 4, wherein
the acquisition unit is configured to sequentially identify the indicated position for each of a plurality of time points on a time axis,
in each of a plurality of processing time intervals on the time axis, the identification unit is configured to execute a path search and thereby identify a time series of two or more reproduction positions that correspond to different time points within at least a part of the processing time interval, two or more indicated positions respectively identified for two or more time points within the processing time interval from among the plurality of time points, and a search condition corresponding to characteristics of the time series signal are applied to the path search, and
the reproduction unit is configured to cause the reproduction device to reproduce portions of the time series signal respectively corresponding to the two or more reproduction positions.

6. The signal processing system according to claim 5, wherein
the processing time interval is a time interval between a first time point and a second time point located after the first time point, from among the plurality of time points, and
at least the part of the processing time interval is an analysis time interval from the first time point to a third time point between the first time point and the second time point.

7. The signal processing system according to claim 6, wherein
the search condition includes a condition for fixing the reproduction position at the first time point to the indicated position at the first time point, and fixing the reproduction position at the second time point to the indicated position at the second time point.

8. The signal processing system according to claim 5, wherein
the search condition includes an observation likelihood at each of the plurality of time points,
the observation likelihood is a probability that each of a plurality of unit time intervals, obtained by dividing the time series signal on a time axis, corresponds to the reproduction position at each of the time points, and
a probability distribution of the observation likelihood is defined by a mean corresponding to the indicated positions.

9. The signal processing system according to claim 8, wherein
the time series signal is an audio signal representing performance sound of the musical piece,
the probability distribution of the observation likelihood at time points at which the indicated positions correspond to sound generation points of the audio signal, from among the plurality of time points, is defined by a first variance, and
the probability distribution of the observation likelihood at time points at which the indicated positions do not correspond to the sound generation points of the audio signal, from among the plurality of time points, is defined by a second variance that is greater than the first variance.

10. The signal processing system according to claim 8, wherein
the search condition includes a variation index representing a degree of variation of characteristics of the time series signal, and
a variance of the probability distribution of the observation likelihood is set in accordance with the variation index.

11. The signal processing system according to claim 5, wherein
the search condition includes a transition probability that is set for each combination of two unit time intervals, from among the plurality of unit time intervals obtained by dividing the time series signal on the time axis, and that represents a probability of the reproduction position transitioning between the two unit time intervals.

12. The signal processing system according to claim 11, wherein
the time series signal is an audio signal representing performance sound of the musical piece, and
the transition probability when the audio signal is silent in both of the two unit time intervals is greater than the transition probability when the audio signal contains sound in one or both of the two unit time intervals.

13. The signal processing system according to claim 12, wherein
the probability distribution of the transition probability when the audio signal contains the sound in one or both of the two unit time intervals is defined by a mean that is set to a prescribed value, and by a variance corresponding to a variation index representing a degree of variation of acoustic characteristics of the audio signal.

14. The signal processing system according to claim 11, wherein
the transition probability of the reproduction position remaining at a last time point of a first inter-sounding time interval, from among a plurality of inter-sounding time intervals obtained by dividing the audio signal on the time axis by a plurality of sound generation points, is greater than the transition probability of the reproduction position transitioning from the last time point to a time point within a second inter-sounding time interval immediately following the first inter-sounding time interval.

15. The signal processing system according to claim 4, wherein
the indicated position is a performance position estimated by the acquisition unit analyzing the user's performance of the musical piece.

16. The signal processing system according to claim 15, wherein
the reproduction unit is configured to
select, in response to a first operation occurring at a first time point in the user's performance and a second operation occurring at a second time point after the first time point has elapsed in the user's performance, as an operating intensity at the second time point, a larger one of a first intensity obtained by reducing an intensity of the first operation over time from the first time point to the second time point, and a second intensity of the second operation, and
control a volume of reproduction sound of the time series signal in accordance with the operating intensity.

17. A signal processing method, realized by a computer, for causing a reproduction device to reproduce a time series signal that follows reproduction of a musical piece, the signal processing method comprising:
acquiring an indicated position indicated by a user in the reproduction of the musical piece; and
executing time stretching of the time series signal in accordance with the indicated position.

18. The signal processing method according to claim 17, wherein
the time series signal is a signal representing audio or video,
in the acquisition of the indicated position, a plurality of indicated positions are acquired over time, and
the time stretching is executed by a path search to which two or more different indicated positions from among the plurality of indicated positions and a search condition in accordance with characteristics of the time series signal are applied.

19. The signal processing method according to claim 17, wherein
the reproduction of the musical piece is the user's performance of the musical piece.

20. A non-transitory computer-readable medium storing a program for causing a reproduction device to reproduce a time series signal that follows reproduction of a musical piece, the program causing a computer to execute a process comprising:
acquiring an indicated position indicated by a user in the reproduction of the musical piece; and
executing time stretching of the time series signal in accordance with the indicated position.
